(19) United States
(12) Patent Application Publication
(10) Pub. No.: US 2021/0177213 A1
(43) Pub. Date: Jun. 17, 2021

(54) COLLAPSIBLE COLANDER AND BOWL

(71) Applicant: Not Til 4 LLC, Greenville, MI (US)

(72) Inventors: Steven M. Young, Greenville, MI (US); Jacob B. Kemp, Rockford, MI (US)

(21) Appl. No.: 17/120,489

(22) Filed: Dec. 14, 2020

Related U.S. Application Data
(60) Provisional application No. 62/947,976, filed on Dec. 13, 2019.

(51) Int. Cl. A47J 43/24; B65D 21/08

(52) U.S. Cl. CPC A47J 43/24; B65D 21/086

(57) ABSTRACT

A collapsible colander and bowl that is extendable to an expanded configuration to selectively form a colander, bowl, or container and foldable to a compact collapsed configuration for storage. The collapsible colander includes an upper rim defining an opening, a perforated bottom panel, a sidewall, a removable top lid, and a removable bottom lid. The sidewall has an upper end secured to the upper rim and a lower end secured to the perforated bottom panel. The sidewall is expandable and collapsible between a collapsed configuration and an expanded configuration. The removable top lid attaches to the upper rim, and the removable bottom lid attaches to the perforated bottom panel.

### CROSS-REFERENCE TO RELATED APPLICATION

The present application claims priority of U.S. provisional application Ser. No. 62/947,976, filed Dec. 13, 2019, which is hereby incorporated herein by reference in its entirety.

### FIELD OF THE INVENTION

This invention relates in general to collapsible containers, such as for temporary food storage.

### BACKGROUND OF THE INVENTION

Bowls, containers and perforated strainers, known in the food preparation art as colanders, are conventional kitchen items, typically formed of a rigid or semi-rigid material, that are self-supporting and have a comparatively fixed volume construction. While it is well-recognized that these tools offer many advantages, such as an ability to store or to be filled with a wide variety of content or foodstuffs and to generally remain their shape configuration, a drawback of all these conventional kitchen tools is that their form requires significant storage space, and thus are difficult to store.

### SUMMARY OF THE INVENTION

The present invention provides for an easy-to-use and convenient-to-store combination of kitchen tools that can be readily and fully flattened or axially collapsed to a minimum size when not in use, expanded for use and be self-supporting when placed on a surface.

The combination of kitchen tools provided by the present invention includes a bowl, a food storage container and a colander, with the added benefit of axially-collapsing to a smaller, more efficient size. The space-saving and multi-application features of the present invention are particularly useful, for example, for storage, in kitchens with minimal storage area and dishwasher cleaning.

According to one form of the present invention, a collapsible colander and bowl includes an upper rim that defines an opening, a perforated bottom panel, a sidewall having an upper end secured to the upper rim and a lower end secured to the perforated bottom panel, a removable top lid designed to be attached to the upper rim, and a removable bottom lid designed to be attached to the perforated bottom panel. The sidewall of the collapsible colander and bowl is adjustable between a collapsed configuration and an expanded configuration.

In one aspect, the top and bottom lids are attachable and detachable in both the collapsed and expanded configurations. The sidewall is foldable from the expanded configuration to the collapsed configuration with at least five regions of the sidewall flexing and expandable from the collapsed configuration to the expanded configuration with the five regions forming at least a portion of the sidewall. The sidewall has a constant wall thickness extending from the upper rim to the perforated bottom panel.

In another aspect, the collapsed configuration of the sidewall is a low-profile configuration with five regions of the sidewall having three concave-up regions alternating with two concave-down regions. In the collapsed configuration, the perforated bottom panel is elevated above the lowermost points of the three concave-up regions. Also, in the collapsed configuration, a top surface of the perforated bottom panel is generally coplanar with an uppermost point of an outermost concave-down region of the sidewall.

In yet another aspect, a top surface of the upper rim includes an upwardly-extending double-ridge formation providing a mounting and sealing surface for the top lid. A bottom surface of the top lid includes a downwardly-extending ridge configured to interlock with the mounting and sealing surface of the upper rim. The bottom lid includes a larger surface area than a surface area of the perforated bottom panel and an upwardly-extending flange confining the surface area of the bottom lid such that the bottom lid is designed to snugly or tightly engage the perforated bottom panel.

In a further aspect, the upper rim and the top lid each have a pair of laterally-extending handle portions with corresponding openings to facilitate manual gripping.

In still another aspect, the sidewall is made at least in part of silicone. The perforated bottom panel is generally planar and the upper rim, perforated bottom panel and sidewall are generally square-shaped with rounded corners.

Aspects of the present specification disclose an all-in-one combination of colander, bowl and container that is configured to flatten from a raised position to a collapsed position. The colander, bowl and container in the raised position are configured to retain food. The colander, bowl and container in the collapsed position is collapsed for storage, optionally with the top and bottom lids remaining attached for convenience.

These and other objects, advantages, purposes and features of the present invention will become apparent upon review of the following specification in conjunction with the drawings.

### BRIEF DESCRIPTION OF THE DRAWINGS

FIG. 1 is a top perspective view of a collapsible colander and bowl in an expanded configuration, in accordance with the present invention;

FIG. 2 is a bottom perspective view of the collapsible colander and bowl illustrated in FIG. 1;

FIG. 3 is a top perspective view of the collapsible colander and bowl illustrated in FIG. 1, shown with top and bottom lids removed;

FIG. 4 is a top perspective view of the collapsible colander and bowl illustrated in FIG. 3, shown in a collapsed configuration;

FIG. 5 is a top plan view of the collapsible colander and bowl illustrated in FIG. 3;

FIG. 6 is a cross-sectional side elevation view of the collapsible colander and bowl of FIG. 3, taken along line VI-VI;

FIG. 7 is a side elevation view of the collapsible colander and bowl illustrated in FIG. 4; and

FIG. 8 is a cross-sectional side view of the collapsible colander and bowl of FIG. 7, taken along line VIII-VIII.

### DETAILED DESCRIPTION OF PREFERRED EMBODIMENTS

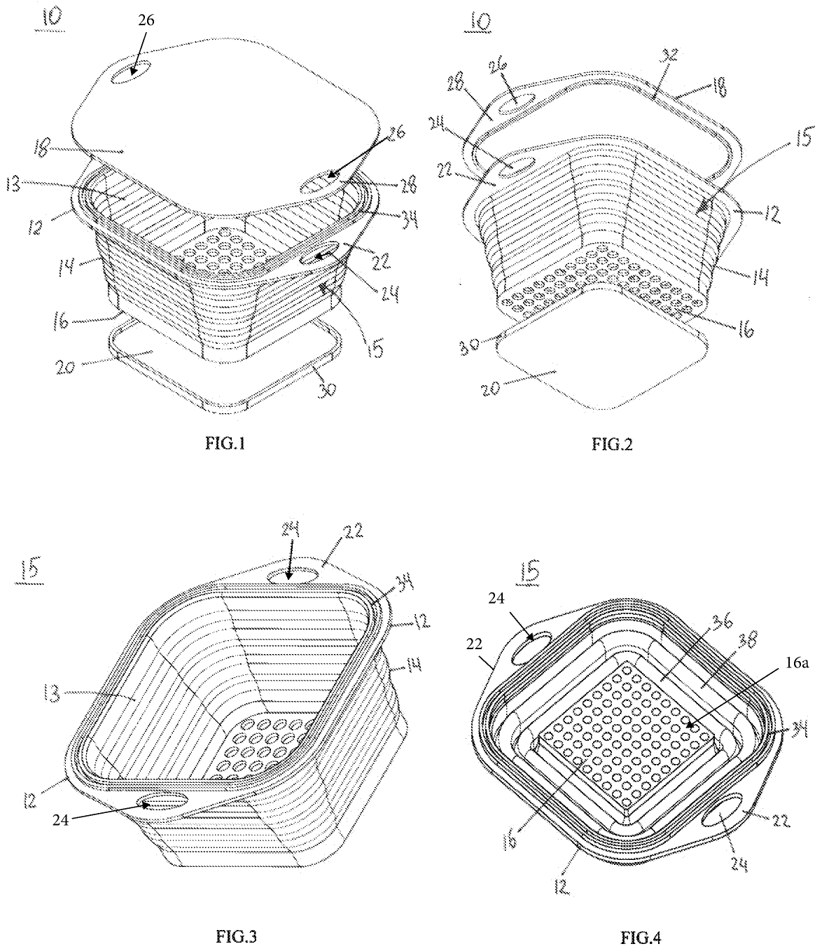

Referring now to the drawings and the illustrative embodiments depicted therein, as best shown in FIGS. 1-2, a collapsible colander and bowl 10 includes an upper rim 12, a mesh or perforated bottom panel 16, a body or sidewall 14, a top lid 18 and a bottom lid 20. Sidewall 14 extends between and connects upper rim 12 and bottom panel 16 such that colander portion 15 is formed, such as shown in FIG. 3. More specifically, an upper end of sidewall 14 is secured to upper rim 12 and a lower end of sidewall 14 is secured to bottom panel 16.

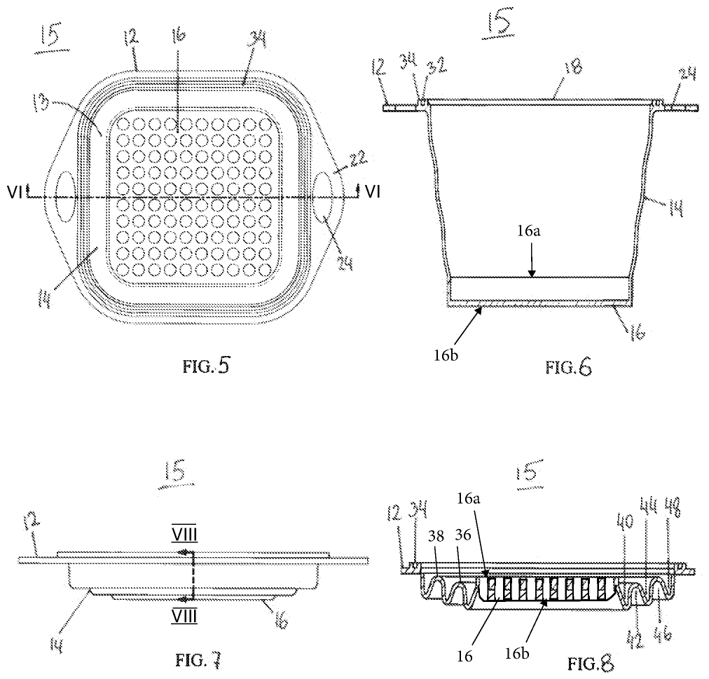

As best shown in FIGS. 3-8, colander portion 15 has at least two selectable configurations. The two selectable configurations are a near-flat storage or collapsed configuration (FIGS. 4 and 7) and an extended use or expanded configuration (FIG. 3). In the storage or collapsed configuration, colander portion 15 is relatively fully flattened or axially collapsed to a minimum size. In the expanded configuration, colander portion 15 is extended to form an open-topped container or bowl. Colander portion 15 is formed to be stable in both the collapsed and expanded configurations. This enables the user to select either configuration, which colander portion 15 will then statically hold indefinitely until it is shifted to the other configuration. Thus, the collapsible colander and bowl can be conveniently stored in the near-flat storage configuration when not in use, and can be extended into the expanded configuration to form a rigid or semi-rigid colander, bowl, or container prior to use.

The top lid 18 is selectively attachable to the upper rim 12 to cover the opening 13, and the bottom lid 20 is selectively attachable at an underside of the perforated bottom panel 16 so that the collapsible colander and bowl 10 can be used as either a colander (when bottom lid 20 is removed), as a bowl (when bottom lid 20 is attached), or as a closed container (when both top and bottom lids 18, 20 are attached). Furthermore, the collapsible colander and bowl 10 is configured such that top and bottom lids 18, 20 may be either attached or removed in both the expanded and collapsed configurations, which allows for compact storage, while reducing the likelihood that the lids 18, 20 will become separated from the colander portion 15 and subsequently lost.

In the collapsed configuration (with top and bottom covers removed), colander portion 15 assumes a low-profile configuration, such as shown in FIGS. 4, 7 and 8. The low-profile or collapsed configuration is characterized by two ribs 36, 38 formed as a result of bending or folding of the sidewall 14. Ribs 36, 38 are formed by three pronounced concave-up regions 40, 44, 48 alternating with two pronounced concave-down regions 42, 46 between the upper rim 12 and the perforated bottom panel 16. Sidewall 14 is thus (A) foldable from the expanded configuration to the collapsed configuration with five separate regions of sidewall 14 flexing significantly (FIGS. 4 and 8), and (B) expandable from the collapsed configuration to the expanded configuration with the five separate regions of sidewall 14 forming at least a portion of the sidewall 14 (FIGS. 1-3 and 6). A thickness of perforated bottom panel 16 is defined by a top surface 16a and a bottom surface 16b (FIGS. 6 and 8).

Referring to FIGS. 4 and 8, which generally depict the collapsible colander and bowl 10 in the collapsed configuration, top surface 16a of the bottom panel 16 assumes a somewhat elevated position above the lowermost points of the three concave-up regions 40, 44, 48 of the colander portion 15. Also, top surface 16a of the bottom panel 16 is at approximately the same elevation as the uppermost point of the outermost concave-down region 46 of the sidewall 14, while bottom surface 16b is raised slightly above the upper most points of the concave-up regions 40, 44 and 48. Although the illustrated embodiment shows the sidewall 14 as forming two ribs 36, 38 with five bending sections 40, 42, 44, 46 and 48, it is envisioned that a variety of other bending formations are possible within the scope of the present invention. For example, the sidewall 14 may be made to flex or bend in three, four, or six regions thereby forming one, three, or four ribs with a variety of alternating concave-up and concave-down regions. Furthermore, it is contemplated that the sidewall 14 of the collapsible colander and bowl 10 in the collapsed configuration may be made to bend such that bottom surface 16b of the bottom panel 16 is lower than the lowermost points of the three concave-up regions 40, 44, 48 of the colander portion 15, or that top surface 16a of the bottom panel 16 in the elevated position may be pressed down to bring the bottom surface 16b of the bottom panel 16 below the lowermost points of the three concave-up regions 40, 44, 48 of the colander portion 15. Further still, as can be best seen in the cross-sectional views of FIGS. 6 and 8, it is envisioned that the collapsible sidewall 14 of colander portion 15 has a generally constant wall thickness extending from the top rim 12 to the bottom panel 16.

Turning now to FIGS. 1 and 3-6, the top surface of the upper rim 12 includes an upwardly-extending double-ridge formation 34, which provides a mounting and sealing surface for top lid 18. The bottom surface of top lid 18, as seen in FIG.2, includes a downwardly-extending ridge 32 designed to interlock or engage with the mounting and sealing surface 34 of the upper rim 12. It should also be appreciated that a variety of other interlocking or attachment features may be provided to securely attach, hold, and/or seal the top lid 18 to the upper rim 12. Both the top rim 12 and the top lid 18 have laterally-extending opposite handle portions 22 and 28, respectively, each with corresponding and generally oval-shaped openings 24 and 26, respectively, to facilitate manual gripping.

In the illustrated embodiment, colander portion 15 and bottom lid 20 are each generally square-shaped with rounded corners. Other shapes of the colander portion and/or the lids are also envisioned, such as circular, oval, or substantially any polygonal shape. Bottom lid 20, having an upwardly-extending perimeter flange 30 (FIGS. 1 and 2) confining the surface area of the bottom lid 20, is configured to snugly or relatively tightly engage the generally planar bottom panel 16 and/or a portion of sidewall 14 to form a fluid-resistant seal. It should also be appreciated that the perimeter flange 30 may also include additional fastening mechanical means, such as a ridge, lip, or recess, to more securely engage the bottom panel 16 and/or a portion of sidewall 14.

It should be understood that materials used for the collapsible colander and bowl 10 are preferably food-grade material(s) so that the collapsible colander and bowl 10 can be safely used with food items. Although sidewall 14 may be made of a silicone material so it is relatively flexible, various combinations of silicone and non-silicone materials that can be used to make sidewall 14 are also contemplated within the scope of the present invention.

As utilized herein, the term “flexible” is utilized to refer to materials which are capable of being flexed or bent, especially repeatedly, such that they are pliant and yieldable in response to externally applied forces. Accordingly, “flexible” is substantially opposite in meaning to the terms inflexible, rigid, or unyielding. Materials and structures which are flexible, therefore, may be altered in shape and structure to accommodate external forces and to conform to the shape of objects brought into contact with them without losing their integrity.

The preferred embodiments described herein thus provide for a collapsible colander and bowl that is extendable to an expanded configuration to selectively form a colander, bowl, or container and foldable to a nearly-flat collapsed configuration for storage.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. A collapsible colander and bowl comprising:
an upper rim defining an opening;
a perforated bottom panel;
a sidewall having an upper end secured to said upper rim and a lower end secured to said perforated bottom panel, wherein said sidewall is expandable and collapsible between a collapsed configuration and an expanded configuration;
a removable top lid configured to attach to said upper rim; and
a removable bottom lid configured to attach to said perforated bottom panel.

2. The collapsible colander and bowl of claim 1, wherein said top and bottom lids are attachable and detachable in both the collapsed and expanded configurations.

3. The collapsible colander and bowl of claim 1, wherein said sidewall is (i) foldable from the expanded configuration to the collapsed configuration with at least five regions of said sidewall flexing and (ii) expandable from the collapsed configuration to the expanded configuration with said at least five regions forming at least a portion of said sidewall.

4. The collapsible colander and bowl of claim 1, wherein said sidewall comprises a constant wall thickness extending from said upper rim to said perforated bottom panel.

5. The collapsible colander and bowl of claim 1, wherein the collapsed configuration of said sidewall is a low-profile configuration with five regions of said sidewall comprising three concave-up regions alternating with two concave-down regions.

6. The collapsible colander and bowl of claim 5, wherein, in the collapsed configuration, said perforated bottom panel is elevated above a lowermost point of said three concave-up regions.

7. The collapsible colander and bowl of claim 1, wherein, in the collapsed configuration, a top surface of said perforated bottom panel is generally coplanar with an uppermost point of an outermost concave-down region of said sidewall.

8. The collapsible colander and bowl of claim 1, wherein a top surface of said upper rim comprises an upwardly-extending double-ridge formation providing a mounting and sealing surface for said top lid.

9. The collapsible colander and bowl of claim 8, wherein a bottom surface of said top lid comprises a downwardly-extending ridge configured to engage with said mounting and sealing surface of said upper rim.

10. The collapsible colander and bowl of claim 1, wherein said upper rim and said top lid each comprise a pair of laterally-extending handle portions with corresponding openings to facilitate manual gripping.

11. The collapsible colander and bowl of claim 1, wherein said bottom lid comprises an upwardly-extending flange confining the surface area of said bottom lid such that said bottom lid is configured to snugly engage said perforated bottom panel.

12. The collapsible colander and bowl of claim 1, wherein said sidewall is made at least in part of silicone.

13. The collapsible colander and bowl of claim 1, wherein said perforated bottom panel is generally planar.

14. The collapsible colander and bowl of claim 1, wherein said upper rim, perforated bottom panel and sidewall are generally square-shaped with rounded corners.

15. A collapsible colander and bowl comprising:
an upper rim defining an opening;
a perforated bottom panel;
a sidewall having an upper end secured to said upper rim and a lower end secured to said perforated bottom panel, wherein said sidewall is expandable and collapsible between a collapsed configuration and an expanded configuration and comprises five flexing regions;
a removable top lid configured to attach to said upper rim; and
a removable bottom lid configured to attach to said perforated bottom panel;
wherein said top and bottom lids are attachable and detachable in both the collapsed and expanded configurations; and
wherein said sidewall is foldable from the expanded configuration to the collapsed configuration in which (a) said five flexing regions comprise three concave-up regions alternating with two concave-down regions, (b) said perforated bottom panel is elevated above a lowermost point of said three concave-up regions, and (c) a top surface of said perforated bottom panel is generally coplanar with an uppermost point of an outermost concave-down region of said sidewall.
